(19) United States
(12) Patent Application Publication
(10) Pub. No.: US 2012/0026137 A1
(43) Pub. Date: Feb. 2, 2012

(54) DRIVING APPARATUS AND DRIVING METHOD OF DISPLAY DEVICE

(75) Inventors: Jae-Wan PARK, Seoul (KR); Myeong-Su KIM, Cheonan-si (KR); Hyun-Seok KO, Cheonan-si (KR); Jung-Hwan CHO, Goyang-si (KR)

(73) Assignee: SAMSUNG ELECTRONICS CO., LTD., Suwon-si (KR)

(21) Appl. No.: 13/090,628

(22) Filed: Apr. 20, 2011

(30) Foreign Application Priority Data
Aug. 2, 2010 (KR) 10-2010-0074722

(51) Int. Cl. G09G 3/20; G09G 3/28

(52) U.S. Cl. 345/204; 345/60

(57) ABSTRACT

A driving apparatus of a display device includes a signal controller including a plurality of driving circuit blocks, where the signal controller receives an image signal, input control signals from an outside and a data driver which receives data driving signals output from the signal controller, where a data transmission clock input to at least one of the plurality of driving circuit blocks of the signal controller is inactive during a blank period of at least one of the input control signals.

This application claims priority to Korean Patent Application No. 10-2010-0074722, filed on Aug. 2, 2010, and all the benefits accruing therefrom under 35 U.S.C. §119, the entire content of which in its entirety is herein incorporated by reference.

### BACKGROUND OF THE INVENTION

(1) Field of the Invention

The general inventive concept relates to a driving apparatus and driving method of a display device.

(2) Description of the Related Art

In general, flat panel displays include a liquid crystal display (“LCD), a plasma display panel (”PDP″), an organic light emitting diode (“OLED”) display, and a field effect display (“FED”), for example.

In particular, the LCD, which is one of the most widely used type of flat panel displays, typically includes two display panels having field generating electrodes such as a pixel electrode and a common electrode, for example, and a liquid crystal layer interposed therebetween. In the LCD, voltages are applied to the field generating electrodes to generate electric field in a liquid crystal layer. When the voltages are generated in the liquid crystal layer, alignments of liquid crystal molecules in the liquid crystal layer are determined, and polarization of light incident to the liquid crystal layer is thereby controlled to displaying images.

Various driving methods for reducing the power consumption of LCDs have been proposed. The LCD typically includes a graphics processing unit (“GPU”) and a liquid crystal panel assembly, and the power consumption of both the GPU and the liquid crystal panel assembly may be reduced to reduce the overall power consumption of the LCD. The driving method for reducing the power consumption of the GPU may include various driving methods based on a type of data signal, for example, a seamless display refresh rate switching (“sDRRS”), which is a method of changing a frame rate, a dynamic refresh rate (“DRR”) for increasing a vertical blank period of a vertical synchronizing signal (“Vsync”), and an nVidia display power saving (“nvDPS”) for increasing a horizontal blank period of a horizontal synchronizing signal (“Hsync”), or the like.

However, the driving method for reducing the power consumption of the graphics processing unit may not be directly applied to the liquid crystal panel assembly, such that all of driving circuit blocks in the signal controller of the liquid crystal panel assembly are activated substantially at all times during an operating period of the signal controller. Thus, a driving circuit block not in an operation for the display operation is also activated, such that the power consumption is not sufficiently reduced.

The operating period of the signal controller may include a booting period and a normal operating period. In general, the booting period is a period for loading a control value required to operate the signal controller into an internal register. The driving circuit blocks that operate for the booting period are also activated during the normal operating period corresponding to a substantial portion of operation period of the signal controller, and the power consumption is thereby substantially high.

A driving circuit block not operating for the display operation may be inactivated to reduce the power consumption thereof by an external pin or an electrically erasable programmable read-only memory (“EEPROM”), or the like. However, the external pin or the EEPROM continuously maintains the control value set in the booting period of the signal controller such that the driving circuit blocks that performs an operation only in a specific period are also activated at all times. Accordingly, the power consumption of is substantially high.

### BRIEF SUMMARY OF THE INVENTION

Exemplary embodiments of the present invention provide a driving apparatus and a driving method of a display device with reduced power consumption of a signal controller of a liquid crystal display.

An exemplary embodiment of the present invention provides a driving apparatus of a display device including: a signal controller including a plurality of driving circuit blocks, where the signal controller receives an image signal, input control signals from an outside and a data driver which receives data driving signals output from the signal controller, where a data transmission clock input to at least one of the plurality of driving circuit blocks in the signal controller is inactive during a blank period of at least one of the input control signals.

In an exemplary embodiment, the driving apparatus of a display device may further include: a clock multiplexer receiving a selection signal and outputting one of a block clock signal and a level fixing signal based on the selection signal,

wherein the clock multiplexer outputs one of the block clock signal and the level fixing signal to the data transmission clock input to an input terminal of at least one sub-circuit block of the plurality of driving circuit blocks.

In an exemplary embodiment, the input control signals comprise a horizontal synchronizing signal and a vertical synchronizing signal.

In an exemplary embodiment, the clock multiplexer may output at least one of the level fixing signals synchronized with the horizontal blank period of the horizontal synchronizing signal and the block clock signal synchronized with the horizontal active period of the horizontal synchronizing signal using the selection signal.

In an exemplary embodiment, when the level fixing signal from the clock multiplexer is input to said at least one sub-circuit of the plurality of driving circuit blocks, the data transmission clock input to said at least one of the plurality of driving circuit blocks may be inactive, such that the data transmission clock has an inactive period.

In an exemplary embodiment, said at least one of the plurality of driving circuit blocks which receives the data transmission clock having the inactive period may be connected to the data driver.

In an exemplary embodiment, the data transmission clock input to said at least one of the plurality of driving circuit blocks of the signal controller may be inactive during a vertical blank period of the vertical synchronizing signal. In an exemplary embodiment, the clock multiplexer may receive a selection signal and outputting one of a block clock signal and a level fixing signal based on the selection signal,

wherein the clock multiplexer outputs one of the block clock signal and the level fixing signal to the data transmission clock input to an input terminal of at least one sub-circuit block of the plurality of driving circuit blocks.

In an exemplary embodiment, the clock multiplexer may output at least one of the level fixing signals synchronized with the vertical blank period of the vertical synchronizing signal and may output the block clock signal synchronized with the vertical active period of the vertical synchronizing signal using the selection signal.

In an exemplary embodiment, when the level fixing signal from the clock multiplexer is input to at least one sub-circuit of the plurality of driving circuit blocks, the data transmission clock input to said at least one of the plurality of driving circuit blocks may be inactive, such that the data transmission clock has an inactive period.

In an exemplary embodiment, at least one of the plurality of driving circuit blocks which receives the data transmission clock having the inactive period is connected to the data driver.

In an exemplary embodiment, the driving apparatus of a display device may further include: a plurality of clock multiplexer receiving the selection signal and outputting one of the block clock signal and the level fixing signal based on the selection signal,

wherein each clock multiplexer outputs one of the block clock signal and the level fixing signal to the data transmission clock input at an input terminal of each sub-circuit block of the plurality of driving circuit blocks.

Another exemplary embodiment of the present invention provides a method for driving a display device including: inputting an image signal, a horizontal synchronizing signal and a vertical synchronizing signal to a signal controller from an outside; inactivating a data transmission clock input to a plurality of driving circuit blocks of the signal controller during the horizontal blank period of the horizontal synchronizing signal; and outputting data driving signals from the signal controller to a data driver.

In an exemplary embodiment, a method for driving a display device may further include inputting a selection signal to a clock multiplexer disposed at an input terminal of at least one each sub-circuit of the plurality of driving circuit blocks, and outputting at least one of a block clock signal and a level fixing signal to the data transmission clock input to the input terminal of asid at least one sub-circuits of the plurality of driving circuit blocks based on a selection signal.

In an exemplary embodiment, the clock multiplexer may output at least one of the level fixing signal synchronized with the horizontal blank period of the horizontal synchronizing signal and the block clock signal synchronized with the horizontal active period of the horizontal synchronizing signal using the selection signal.

In an exemplary embodiment, when the level fixing signal from the clock multiplexer is input to the data transmission clock, the data transmission clock input to at least one of the plurality of driving circuit blocks may be inactive, such that the data transmission clock has an inactive period.

In an exemplary embodiment, the data transmission clock input to said at least one of the plurality of driving circuit blocks of the signal controller may be inactive during a vertical blank period of the vertical synchronizing signal.

In an exemplary embodiment, the clock multiplexer may output at least one of the level fixing signal synchronized with the vertical blank period of the vertical synchronizing signal and the block clock signal synchronized with a vertical active period of the vertical synchronizing signal using the selection signal.

According to exemplary embodiments of the present invention, each data transmission clock input to the plurality of driving circuit blocks in the signal controller is inactive by the clock multiplexer during the horizontal blank period of the horizontal synchronizing signal and the vertical blank period of the vertical synchronizing signal, and the power consumption of the signal controller in a liquid crystal display device is thereby substantially reduced.

### BRIEF DESCRIPTION OF THE DRAWINGS

The above and other features of this disclosure will become more apparent by describing in further detail exemplary embodiments thereof with reference to the accompanying drawings, in which:

FIG. 1 is a block diagram of an exemplary embodiment of a display device according to the present invention;

FIG. 2 is an equivalent circuit diagram of a pixel of the display device in FIG. 1;

FIG. 3 is a block diagram of a signal controller of an exemplary embodiment of the display device according to the present invention;

FIG. 4 is a diagram showing a horizontal synchronizing signal and a vertical synchronizing signal input to the signal controller of the display device according to the exemplary embodiment of the present invention; and

FIG. 5 is a signal timing diagram showing an operation of the signal controller of an exemplary embodiment of the display device according to the present invention.

FIG. 6 is a block diagram of a signal controller of another exemplary embodiment of the display device according to the present invention.

### DETAILED DESCRIPTION OF THE INVENTION

The invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in detail with reference to the accompanying drawings.

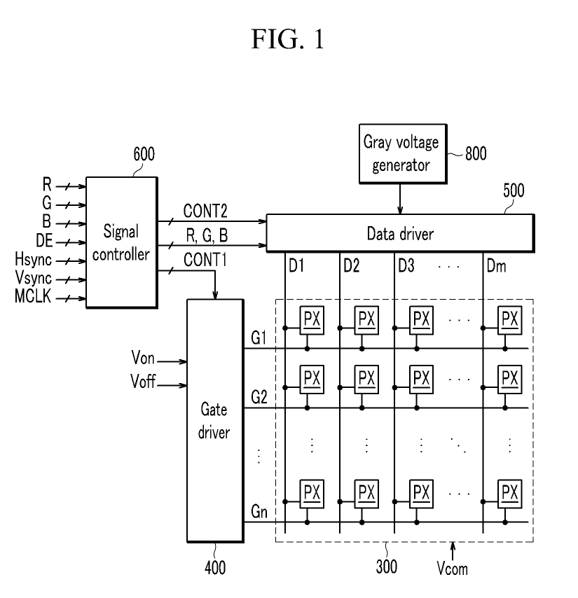

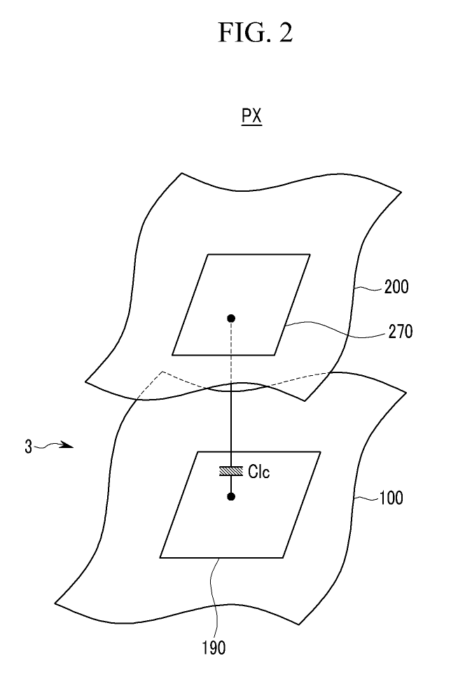

An exemplary embodiment of a display device according to the present invention will be described in detail with reference to FIGS. 1 and 2.

FIG. 1 is a block diagram of an exemplary embodiment of a display device according to the present invention, and FIG. 2 is an equivalent circuit diagram of a pixel of the display device in FIG. 1.

Referring to FIG. 1, an exemplary embodiment of a display device includes a display panel assembly 300, a gate driver 400, a data driver 500, a gray voltage generator 800 and a signal controller 600.

Referring to FIG. 1, the display panel assembly 300 includes a plurality of signal lines G₁-Gₙ, and D₁-Dₘ and a plurality of pixels PX connected to the plurality of signal lines and arranged substantially in a matrix form, when being viewed in an equivalent circuit. As shown in FIG. 2, an exemplary embodiment of the display panel assembly 300 may include a lower panel 100, an upper panel 200 disposed opposite to, e.g., facing, the lower panel 100, and a liquid crystal layer 3 interposed between the lower panel 100 and the upper panel 200. Although the exemplary embodiment of the display device shown in FIG. 2 is the liquid crystal display, exemplary embodiments of the display device according to the present invention is not limited to a liquid crystal display (“LCD”). In alternative exemplary embodiment, the display device may be other types of flat display panels such as a plasma display (“PDP”), an organic light emitting diode display (“OLED”), or the like, for example.

The signal lines G₁-Gₙ, and D₁-Dₘ include a plurality of gate lines G₁-Gₙ, which transfers gate signals (also referred to as “scanning signal”) and a plurality of data lines D₁ Dₘ which transfers data voltages. The plurality of gate lines G₁-Gₙ, extends substantially in a row direction and substantially parallel with each other, and the plurality of data lines D₁-Dₘ extends substantially in a column direction and substantially parallel with each other.

In an exemplary embodiment, each of the plurality of pixels PX is connected to corresponding signal liens of the plurality of signal lines G₁-Gₙ, and D₁-Dₘ, e.g., an i-th (i=1, 2, . . . , n) gate line G, and a j-th (j=1, 2, . . . , m) data line Dⱼ, and includes a switching device connected to the corresponding signal lines, e.g., the i-th gate line Gi and the j-th data line Dj, and a liquid crystal capacitor Clc and a storage capacitor, which are connected to the switching device. In an alternative embodiment, the storage capacitor may be omitted.

The switching device may be a three-terminal device such as a thin film transistor disposed in a lower panel 100. In an exemplary embodiment, a control terminal of the switching device is connected to a corresponding gate line, e.g., the i-th gate line G, an input terminal of the switching device is connected to a corresponding data line, e.g., the j-th data line Dⱼ, and an output terminal of the switching device is connected to the liquid crystal capacitor Clc and the storage capacitor.

The liquid crystal capacitor Clc may use a pixel electrode 190 of the lower panel 100 and a common electrode 270 of the upper panel 200 as two terminals thereof, and the liquid crystal layer 3 disposed between the pixel electrode 190 and the common electrode 270 may function as a dielectric material. The pixel electrode 190 is connected to the switching device and the common electrode 270 is formed over the upper panel 200 to receive a common voltage Vcom (FIG. 1). Unlike FIG. 2, when the common electrode 270 is provided on the lower panel 100, at least one of the pixel electrode 190 and the common electrode 270 may be a linear type electrode or a bar type electrode.

In an exemplary embodiment, the storage capacitor, which performs an auxiliary role of the liquid crystal capacitor Clc, may be formed by a separate signal line (not shown) provided in the lower panel 100, the pixel electrode 190 overlapping the separate signal line and an insulator interposed between the separate signal line and the pixel electrode 190, where a predetermined voltage such as the common voltage Vcom, for example, is applied to the separate signal line. In an alternative exemplary embodiment, the storage capacitor may be formed by the pixel electrode 190, a previous gate line, e.g., a (i-1)-th gate line Gᵢ₋₁, overlapping the pixel electrode 190, and an insulator disposed between the pixel electrode 190 and the previous gate line, e.g., the (i-1)-th gate line Gᵢ₋₁.

In an exemplary embodiment, each of the plurality of pixels PX may display a predetermined color of primary colors (spatial division), or each of the plurality of pixels PX may alternately display the primary colors over time (temporal division), and a desired colors is thereby recognized by the spatial or temporal sum of the primary colors. In an exemplary embodiment, the primary colors may include red, green and blue, for example.

The liquid crystal panel assembly 300 may include at least one polarizer (not shown).

Hereinafter, a driving apparatus of an exemplary embodiment of the display device according to the present invention will be described in detail.

Referring back to FIG. 1, the driving apparatus includes the gate driver 400, the data driver 500, the signal controller 600 and gray voltage generator 800. The gray voltage generator 800 may generate gray voltages corresponding to the transmittance of the plurality of pixels PX or at least a portion of the entire gray voltages. The gray voltages may have a positive polarity or a negative polarity with respect to a polarity of the common voltage Vcom.

The gate driver 400 is connected to the plurality of gate lines G₁-Gₙ, of the liquid crystal panel assembly 300 and applies the gate signals, which includes a gate-on voltage Von, a gate-off voltage Voff or a combination thereof, to the plurality of gate lines G₁-Gₙ.

The data driver 500 is connected to the plurality of data lines D₁-Dₘ of the liquid crystal panel assembly 300, and selectively applies the gray voltages generated from the gray voltage generator 800 to the plurality of data lines D₁-Dₘ as the data voltages. In an exemplary embodiment, when the gray voltage generator 800 does not provide the entire gray voltages but provides only a portion of the entire gray voltages, the data driver 500 generates the data voltages by dividing the portion of the entire gray voltages.

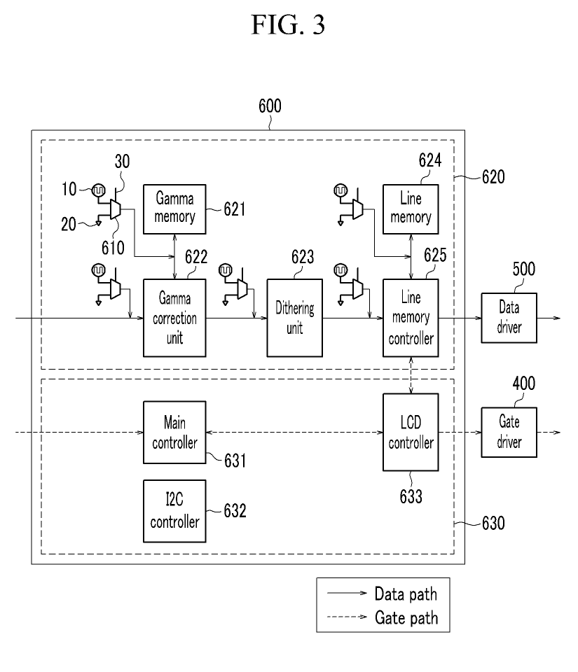

The signal controller 600 controls the gate driver 400 and the data driver 500, or the like. FIG. 3 is a block diagram of the signal controller of an exemplary embodiment of the display device according to the present invention. As shown in FIG. 3, a signal controller 600 includes a plurality of driving circuit blocks. The plurality of driving circuit blocks includes a data driving circuit block 620 disposed in a data path, along which data signals are transferred, and a gate driving circuit block 630 disposed in a gate path, along which gate signals are transferred.

In an exemplary embodiment, the data driving circuit block 620 may include sub-circuits, e.g., a gamma memory 621, a gamma correction unit 622, a dithering unit 623, a line memory 624 or a line memory controller 625, or the like and the gate driving circuit blocks 630 may include sub-circuits, e.g., a main controller 631, an inter-integrated circuit (“I2C”) controller 632 an LCD controller 633, or the like.

In an embodiment, a clock multiplexer 610 may be disposed at an input end of each sub-circuit block of the plurality of driving circuits, e.g., an input terminal of each sub-circuit of the data driving circuit block 620 and the gate driving circuit block 630.

In an exemplary embodiment, each member of the driving apparatus, e.g., the gate driver 400, the data driver 500, the signal controller 600 and gray voltage generator 800, may be disposed directly on the liquid crystal panel assembly 300 in the form of at least one integrated circuit chip. In an alternative exemplary embodiment, each member of the driving apparatus, e.g., the gate driver 400, the data driver 500, the signal controller 600 and gray voltage generator 800, may be disposed on a flexible printed circuit film (not shown) to be attached to the liquid crystal panel assembly 300 in a tape carrier package (“TCP”), or on a separate printed circuit board (not shown). In an exemplary embodiment, at least one member of the driving apparatuses, e.g., the gate driver 400, the data driver 500, the signal controller 600 or gray voltage generator 800, may be integrated in liquid crystal panel assembly 300, together with the signal lines G₁-Gₙ, and D₁-Dₘ and a thin film transistor switching device, and the like. In an exemplary embodiment, at least one member of the driving apparatus, e.g., the gate driver 400, the data driver 500, the signal controller 600 or gray voltage generator 800, may be integrated in a single chip, and at least one circuit device of the at least one member or at least one of the at least one member may be disposed outside the single chip.

Hereinafter, operation of an exemplary embodiment of the display device will be described in detail.

The signal controller 600 receives the input image signals R, G and B and the input control signal that controls the display of the input image signals R, G and B from an external device (not shown), e.g., an external graphics processing unit. The input image signals R, G and B includes luminance information of each of the plurality of pixels PX, where the luminance corresponds to a predetermined number of gray scale, for example, 1024=2¹⁰, 256=2⁸ or 64=2⁶ gray scale. In an exemplary embodiment, the input control signal may include a vertical synchronizing signal Vsync, a horizontal synchronizing signal Hsync, a main clock signal MCLK and a data enable signal DE, for example.

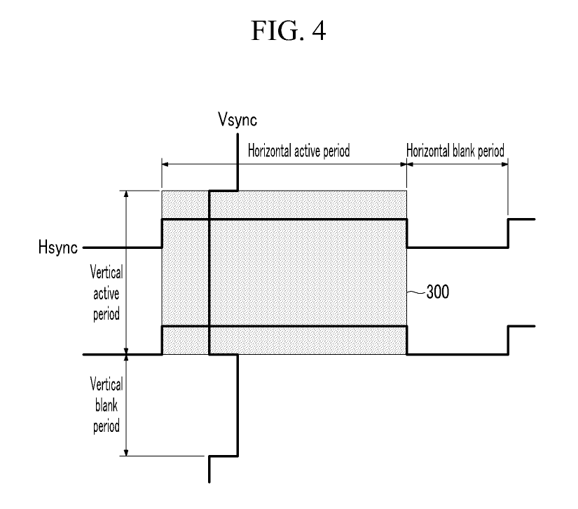

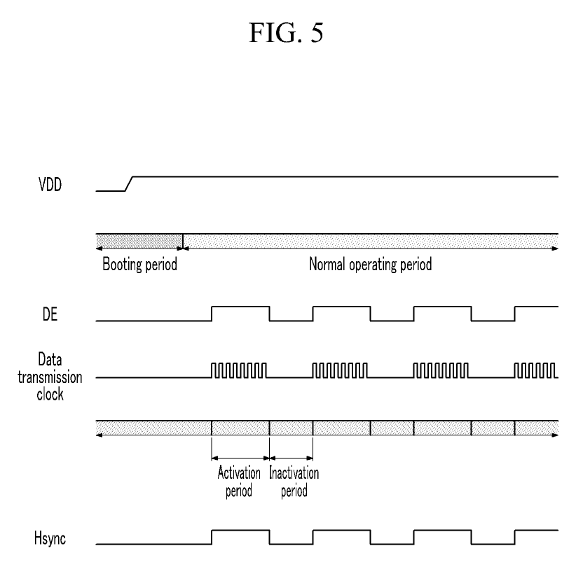

FIG. 4 is a diagram showing a horizontal synchronizing signal and a vertical synchronizing signal input to the signal controller of an exemplary embodiment of the display, and FIG. 5 is a signal timing diagram showing an operation of the signal controller of an exemplary embodiment of the display device.

As shown in FIG. 4, the horizontal synchronizing signal Hsync input from an external device, e.g., the external graphics processing unit, to the signal controller 600 includes a horizontal active period, in which the signal is in a high state, and a horizontal blank period, in which the signal is in a low state, and the vertical synchronizing signal Vsync includes a vertical active period, in which the signal is in a high state, and a vertical blank period, in which the signal is in a low state. In an alternative exemplary embodiment, the signal of the horizontal synchronizing signal Hsync may be in a high state in a horizontal blank period, the signal of the horizontal synchronizing signal Hsync may be in a low state in a horizontal active period. In an alternative exemplary embodiment, the signal of the vertical synchronizing signal Vsync may be in a high state in a vertical blank period, the signal of the vertical synchronizing signal Vsync may be in a low state in a vertical active period.

The gate signals are transmitted during the horizontal active period, but the gate signals are not transmitted during the horizontal blank period, and the data signals are transmitted during the vertical active period, but the data signals are not transmitted during the vertical blank period.

Therefore, a data transmission clock input to the data driving circuit block 620 in the signal controller 600 is inactive by the clock multiplexer 610 during the horizontal blank period of the horizontal synchronizing signal, and the data driving circuit block 620 not in an operation for the display operation is thereby inactive. Therefore, the power consumption is substantially reduced, the access time of the data driving circuit block 620, whose temperature is relatively high at the time of operation, is substantially reduced, and the reliability is thereby substantially improved.

In addition, the data transmission clock to the data driving circuit block 620 in the signal controller 600 is inactive by using the clock multiplexer 610 during the vertical blank period of the vertical synchronizing signal, and the data driving circuit block 620 not in an operation for the display operation is thereby inactive. Therefore, the power consumption is substantially reduced, the access time of the data driving circuit block 620 whose temperature is relatively high at the time of operation is substantially reduced, and the reliability is thereby substantially improved.

Hereinafter, an operation of the clock multiplexer will be described in greater detail with reference to FIGS. 3 and 5.

As shown in FIG. 3, a selection signal is input to a selection signal line 30 of the clock multiplexer 610. The clock multiplexer 610 outputs a level fixing signal 20 synchronized with the horizontal blank period of the horizontal synchronizing signal or a block clock signal 10 synchronized with the horizontal active period of the horizontal synchronizing signal based on the selection signal input to the selection signal line 30.

In an exemplary embodiment, a period of the horizontal synchronizing signal is substantially the same as a period of the data enable signal DE.

In addition, the clock multiplexer 610 outputs the level fixing signal 20 synchronized with the vertical blank period of the vertical synchronizing signal or the block clock signal 10 synchronized with the vertical active period of the vertical synchronizing signal based on the selection signal input to the selection signal line 30.

When a power voltage VDD is applied to the signal controller 600 and is in a normal operating period following a booting period, the data transmission clock is applied to the data driving circuit block 620 in the signal controller 600 during the normal operating period.

In an exemplary embodiment, when the block clock signal 10 is input to the data transmission clock of the data driving circuit block 620 based on the selection signal input to the clock multiplexer 610 through the selection signal line 30, the data transmission clock of the data driving circuit block 620 is activated and thereby has an activation period as shown in FIG. 5, and the data driving circuit 620 is normally operated during the activation period of the data transmission clock. In an exemplary embodiment, the block clock signal 10 input to the data transmission clock may be input to an input terminal of the data driving circuit block, e.g., a clock port or a data port of a flip-flop of the data driving circuit block 620.

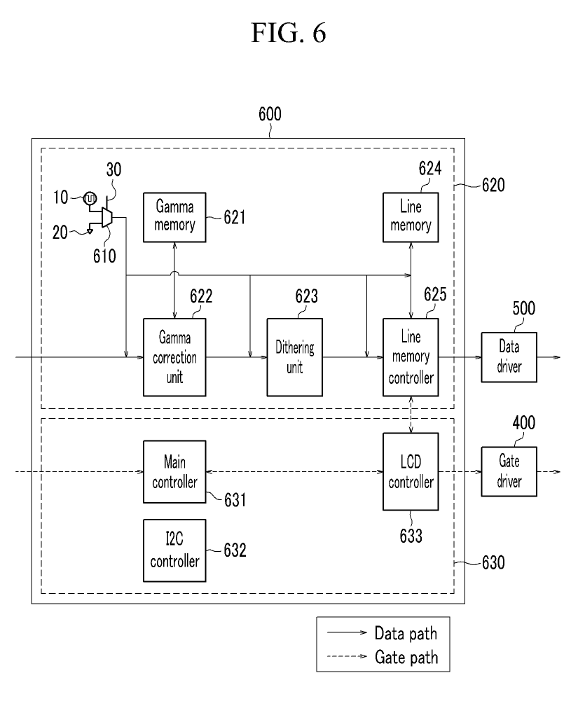

When the level fixing signal 20 is input to the input terminal of the data driving circuit block, e.g., the clock port or the data port of the flip-flop of the data driving circuit block 620, based on the selection signal, the data transmission clock of the data driving circuit block 620 is inactive and thereby has an inactivation period as shown in FIG. 5. In an exemplary embodiment, the data driving circuit block 620 is not operating during the inactivation period, and the power consumption of the display device is thereby substantially reduced. In an exemplary embodiment, each of the sub-circuit of the data driving circuit block 620 may receive the selection signal output from the same clock multiplexer as shown in FIG. 6.

The signal controller 600 processes the input image signals R, G and B for the operation of the liquid crystal panel assembly 300 based on the input control signal, generates control signals including a gate control signal CONT1 (FIG. 1) and a data control signal CONT2 (FIG. 1), for example, and then transmits the gate control signal CONT1 to the gate driver 400 and transmits the data control signal CONT2 and processed image signals R′, G′ and B′ to the data driver 500.

The gate control signal CONT1 includes a scanning start signal that signals a scanning start and at least one clock signal that controls an output period of the gate-on voltage Von. The gate control signal CONT1 may further include the output enable signal that controls the sustain time of the gate-on voltage Von.

The data control signal CONT2 includes a horizontal synchronization start signal that signals the transmission start of the digital image signal for a row of the pixels PX, a load signal that signals an application of an analog data voltage to the plurality of data lines D₁-Dₘ, and a data clock signal. The data control signal CONT2 may further include a reverse signal that inverts a polarity of the data voltage with respect to a polarity of the common voltage Vcom (hereinafter, “polarity of data voltage for common voltage” is referred to as “polarity of data voltage”).

In an exemplary embodiment, the data driver 500 receives the processed image signals R′, G′ and B′ for a row of the pixels PX, selects a gray voltage corresponding to each of the processed image signals R′, G′ and B′, converts the processed image signals R′, G′ and B′ into the analog data voltage based on the data control signal CONT2 from the signal controller 600, and applies the analog data voltage to corresponding data lines of the plurality of data lines D₁-Dₘ.

The gate driver 400 applies the gate-on voltage Von to the plurality of gate lines G₁-Gₙ, based on the gate control signal CONT1 from the signal controller 600 to turn-on the switching device connected to the plurality of gate lines G₁-Gₘ Then, the data voltage applied to the plurality of data lines D₁-Dₘ is transmitted to a corresponding pixel through a turned-on switching device.

The difference between the data voltage applied to a pixel and the common voltage Vcom applied to the pixel corresponds to a charging voltage of the liquid crystal capacitor Clc (also referred to as “pixel voltage”). Arrangements of the liquid crystal molecules may vary based on the magnitude of the pixel voltage, and the polarization of light passing through the liquid crystal layer is thereby changed. The change in polarization of the light passing through the liquid crystal layer corresponds to a change in light transmittance by a polarizer, and the pixel PX displays the luminance corresponding to the gray of the image signal.

The images of one frame are displayed by sequentially applying the gate-on voltage Von to all of the plurality of gate lines G₁-Gₙ and applying the data voltage to all of the plurality of pixels PX by repeating the process using a one horizontal period that is substantially the same as one period of the horizontal synchronizing signal Hsync and the data enable signal DE as a unit.

In an exemplary embodiment, a subsequent frame starts after one frame and the state of a reverse signal, which is applied to the data driver 500 such that the polarity of the data voltage applied to each pixel during a frame is opposite to the polarity of data voltage applied during a previous frame (“frame inversion”), is controlled. In an exemplary embodiment, even in one frame, the polarity of the data voltage flowing through one data line may be periodically changed (e.g., row inversion, dot inversion) or the polarity of the data voltage applied to one pixel row may be different from each other (e.g., column inversion, dot inversion) based on the characteristics of the reverse signal.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving apparatus of a display device, the driving apparatus comprising:
a signal controller comprising a plurality of driving circuit blocks, wherein the signal controller receives an image signal, input control signals from an outside; and
a data driver which receives data driving signals output from the signal controller,
wherein a data transmission clock input to at least one of the plurality of driving circuit blocks of the signal controller is inactive during a blank period of at least one of the input control signals.

2. The apparatus of claim 1, further comprising:
a clock multiplexer receiving a selection signal and outputting one of a block clock signal and a level fixing signal based on the selection signal,
wherein the clock multiplexer outputs one of the block clock signal and the level fixing signal to the data transmission clock input to an input terminal of at least one sub-circuit block of the plurality of driving circuit blocks.

3. The apparatus of claim 2, wherein:
The input control signals comprise a horizontal synchronizing signal and a vertical synchronizing signal.

4. The apparatus of claim 3, wherein:
the clock multiplexer outputs one of the level fixing signal synchronized with the horizontal blank period of the horizontal synchronizing signal and the block clock signal synchronized with a horizontal active period of the horizontal synchronizing signal using the selection signal.

5. The apparatus of claim 4, wherein:
when the level fixing signal from the clock multiplexer is input to said at least one sub-circuit block of the plurality of driving circuit blocks, each data transmission clock input to said at least one of the plurality of driving circuit blocks is inactive, such that the data transmission clock has an inactive period.

6. The apparatus of claim 5, wherein:
said at least one of the plurality of driving circuit blocks which receives the data transmission clock having the inactive period is connected to the data driver.

7. The apparatus of claim 3, wherein:
the data transmission clock input to said at least one of the plurality of driving circuit blocks of the signal controller is inactive during a vertical blank period of the vertical synchronizing signal.

8. The apparatus of claim 7, further comprising:
a clock multiplexer receiving a selection signal and outputting one of a block clock signal and a level fixing signal based on the selection signal,
wherein the clock multiplexer outputs one of the block clock signal and the level fixing signal to the data transmission clock input to an input terminal of at least one sub-circuit block of the plurality of driving circuit blocks.

9. The apparatus of claim 8, wherein:
the clock multiplexer outputs at least one of the level fixing signal synchronized with the vertical blank period of the vertical synchronizing signal and the block clock signal synchronized with a vertical active period of the vertical synchronizing signal using the selection signal.

10. The apparatus of claim 8, wherein:
when the level fixing signal from the clock multiplexer is input to said at least one of sub-circuit block of the plurality of driving circuit blocks, the data transmission clock input to said at least one of the plurality of driving circuit blocks is inactive, such that the data transmission clock has an inactive period.

11. The apparatus of claim 10, wherein:
at least one of the plurality of driving circuit blocks which receives the data transmission clock having the inactive period is connected to the data driver.

12. The apparatus of claim 1, further comprising:
a plurality of clock multiplexer receiving the selection signal and outputting one of the block clock signal and the level fixing signal based on the selection signal,
wherein each clock multiplexer outputs one of the block clock signal and the level fixing signal to the data transmission clock input at an input terminal of each sub-circuit block of the plurality of driving circuit blocks.

13. A method for driving a display device, comprising:
inputting an image signal, a horizontal synchronizing signal and a vertical synchronizing signal to a signal controller from an outside;
inactivating a data transmission clock input to a plurality of driving circuit blocks of the signal controller during a horizontal blank period of the horizontal synchronizing signal; and
outputting data driving signals from the signal controller to a data driver.

14. The method of claim 13, further comprising:
inputting a selection signal to a clock multiplexer disposed at an input terminal of at least one sub-circuit block of the plurality of driving circuit blocks; and
outputting at least one of a block clock signal and a level fixing signal to the data transmission clock input to the input terminal of said at least one sub-circuit block of the plurality of driving circuit blocks based on the selection signal. .

15. The method of claim 14, wherein:
the clock multiplexer outputs at least one of the level fixing signal synchronized with the horizontal blank period of the horizontal synchronizing signal and the block clock signal synchronized with a horizontal active period of the horizontal synchronizing signal using the selection signal.

16. The method of claim 15, wherein:
when the level fixing signal is input from the clock multiplexer to the data transmission clock, the data transmission clock input to at least one of the plurality of driving circuit blocks is inactive, such that the data transmission clock has an inactive period.

17. The method of claim 13, further comprising:
inactivating the data transmission clock input to said at least one of the plurality of driving circuit blocks of the signal controller during vertical blank period of the vertical synchronizing signal.

18. The method of claim 17, further comprising:
inputting a selection signal to a clock multiplexer disposed at an input terminal of said at least one sub-circuit block of the plurality of driving circuit blocks; and
outputting at least one of a block clock signal and a level fixing signal to the data transmission clock input to the input terminal of said at least one sub-circuit block of the plurality of driving circuit blocks based on the selection signal.

19. The method of claim 18, wherein:
the clock multiplexer outputs at least one of the level fixing signal synchronized with the vertical blank period of the vertical synchronizing signal and the block clock signal synchronized with the vertical active period of the vertical synchronizing signal using the selection signal.

20. The method of claim 19, wherein:
when the level fixing signal is input from the clock multiplexer to the data transmission clock, the data transmission clock input to the plurality of driving circuit blocks is inactive, such that the data transmission clock has an inactive period.
